(19) United States
(12) Patent Application Publication
(10) Pub. No.: US 2007/0234279 A1
(43) Pub. Date: Oct. 4, 2007

(54) System and method for creating designs for over the phone voice enabled services

(76) Inventors: Wally Brill, West Hollywood, CA (US); Diego Montefusco, Cagliari (IT); Melissa Dougherty, Palo Alto, CA (US); Phillip Hunter, Ouray, CO (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/367,255

(22) Filed: Mar. 2, 2006

Related U.S. Application Data
(60) Provisional application No. 60/658,477, filed on Mar. 3, 2005.

(51) Int. Cl. G06F 9/44

(52) U.S. Cl. 717/104

(57) ABSTRACT

A system and method for creating designs for over the phone voice enabled services is provided. The system and method provide an automated way to start with a sample dialog, view and edit its content in both a detail dialog design format and a flowchart format, and automatically create (1) a prompt recording script; (2) a high fidelity prototype system for usability testing; and (3) an XML file for importing into a development environment.

### RELATED APPLICATION/PRIORITY CLAIM

This application claims priority under 35 USC 119(e) to U.S. Provisional Patent Application Ser. No. 60/658,477 filed on Mar. 3, 2005 and entitled “Computer-Aided Creation of User-Centered Designs for Over-the-Phone Voice Enabled Services” which is incorporated herein by reference.

### FIELD OF THE INVENTION

The invention relates generally to a system and method for creating a design for an over the phone voice enabled service.

### BACKGROUND OF THE INVENTION

Over-the-phone voice user interfaces are heralded as the next generation in customer service: Companies implement these systems to improve customer service, call completion and customer satisfaction. However, over-the-phone voice recognition systems often do not reach their goals, because the services implemented do not represent a step forward in usability: frustrated callers continue to “opt out” to a representative a large portion of the time (often 40-60% of the time, not substantially less than the figure for touchtone systems). Cooperative callers may not understand what to say, and experience enough errors that the system transfers them automatically to a representative. This situation is not due to a shortcoming in the technology: speech recognition technology is regularly implemented with recognition rates of 97%, and is capable of dramatically improving automation over the phone. Instead, the shortcomings of today's speech systems are a result of their design. While companies are focused on improving both automation rates and customer satisfaction, the predominant design process is driven by developers who make technical decisions about the easiest way for the back-end systems to work, or who mimic the design of existing touchtone systems.

It has been proven in both academic research and corporate usability research, and is the accepted wisdom among experts in the industry, that conversational interactions are easier for the caller to complete. Conversational design requires that the design process begins by defining “sample dialogs” (potential “conversations” between the system and the caller in which the caller utterance and required system response is outlined). At present, this step generally does not occur. Most companies that are responsible for defining voice interactions do not use this process, as system designers are actually developers who start by defining a system flow using state diagrams. System prompts (the words the system says to the caller) are then added to that flow. It is impossible to create an easy-to-use system in this manner. The user finds themselves confronted by a set of options that don't map easily to their needs, presented in language that more accurately correlates to a description of what the system needs in order to function.

For sample dialogs to be a viable starting point for the design process, there will need to be a tool that allows these sample interactions between caller and system to actually become the initial framework for the detailed dialog design. A tool that provides this functionality does not exist today.

Academic and corporate research has also proven that early usability research studies improve the chances of business success for a particular implementation, by improving the usability of the result, and reducing the cost and time for deployment by reducing the number of necessary changes to a developed system. For usability testing to occur early in the design process (among actual target users of the system, not members of the internal team or their friends/relatives), it must be possible to create a high fidelity prototype from initial sample dialogs.

Thus, it is desirable to provide a system and method for creating designs for over the phone voice enabled services and it is to this end that the present invention is directed.

### SUMMARY OF THE INVENTION

A system and method for creating designs for over the phone voice enabled services is provided. The system and method provide an integrated editing environment which offers different editable “views” of the design itself: the design process starts with simple text documents describing sample interactions with the system (“sample dialogs”), then proceeds to the detailed dialog design phase where the content of those sample dialogs is displayed in a state-by-state context and where the designer can add the information which is lacking from the initial sample dialogs (error recovery prompts, application-flow information based on user responses or application conditions, etc). The design can also be displayed and edited in a “flowchart” view which graphically displays the navigation flow across the design. Since all the views are generated from a common dataset, any change the designer makes in any view is automatically reflected when displaying the design in the others, thus insuring the consistency of the design.

The design tool can automatically create (1) a prompt recording script; (2) a high fidelity prototype system for usability testing; and (3) an XML description of the design suitable for importing into a development environment. The system may preferably be implemented as software that may be executed by a typical computing device, such as a personal computer, without any special configuration or other additional software.

The design tool provides an automation and structural framework that will enable the implementing company to use a best practices process for user centered design of speech systems (starting with sample dialogs, testing an early prototype with users, and iterating the resulting design for better performance, prior to finalizing the detailed design specification). In a preferred embodiment, the design tool is implemented as design software.
The design tool provides automation that will allow designers to re-use their sample dialogs to create a dialog specification. At present, any time invested in sample dialogs can not be applied towards any future deliverable—and this step is often skipped as a result.
The tool provides templates and indexed storage for all the activities of context gathering, preliminary to the actual design work.
The design tool provides automation of prototype creation, eliminating build time for the prototype and allowing the designer to create their own prototypes (eliminating the need for the HTML programmer). The design tool also makes it just as easy to usability test a prototype system as a finished system—eliminating the hurdle to the early design research that will save implementing companies time and money.
The design tool provides the ability to view and edit the design in multiple formats: sample dialogs, detailed design specification and flowchart. This eliminates the need for the designer to manually translate material in the sample dialogs into the specification format, or to manually create a flowchart from the specification format, saving time, preventing errors, and maintaining the consistency of the design across the different views and over time. The designer need only add required additional information to each “view” offered by the software, saving time and ensuring completeness of the specification. The design tool then exports XML which can be used in any development environment.
The design tool provides automatic creation of prompt recording scripts, and checks the audio file names actually delivered by the recording studio against what was expected, which will ensure that prompt recording is as error free as possible.
The design tool assists the designer in the maintenance of the design for the life cycle of the application, allowing for post-deployment changes and addition of new features, by keeping track of changes and identifying new prompts to be recorded.

Thus, in accordance with the invention, a computer implemented design tool for an over the phone voice enabled service is provided. The design tool has a storage unit that stores one or more design templates. The design templates describe common over-the-phone applications that (1) represent best practices, (2) are usability tested; and/or (3) market proven. Once a design template is opened in the design software, it may be viewed and edited as a sample dialog, detailed design specification, flowchart or prompt recording script. Changes applied to any of these “views” will be automatically reflected across the others, maintaining the internal coherence of the design. This enables the designer to use the best practices process to edit and test the templates to ensure that they match the business and user goals of their company. The design template may also be automatically converted into a research prototype.

### BRIEF DESCRIPTION OF THE DRAWINGS

FIG. 1 is a diagram illustrating an example of a personal computer implementation of a design tool for over the phone voice enabled services;

FIG. 2 is a flowchart illustrating a method for over the phone voice enabled services design in accordance with the invention;

FIG. 3 illustrates an exemplary user interface for gathering context for the design method;

FIG. 4 illustrates an exemplary user interface for sample dialogs and high level design for the design process;

FIG. 5 illustrates an example of a sample dialog template and usage instructions document for the design process;

FIG. 6 illustrates an example of a detailed design template for the design process;

FIG. 7 illustrates an example of a prototype template of the design process;

FIG. 8 illustrates an example of a prompt recording script template of the design process;

FIG. 9 illustrates an example of generating a detailed design specification during the design process;

FIG. 10 illustrates an example of generating a system prototype during the design process;

FIG. 11 illustrates an example of generating a prompt recording script during the design process; and

FIG. 12 illustrates an example of a user interface of the tool showing the flowchart and the detailed design specification views of the design.

### DETAILED DESCRIPTION OF A PREFERRED EMBODIMENT

The invention is particularly applicable to a system implemented in software on a personal computer system and it is in this context that the invention will be described. It will be appreciated, however, that the system and method in accordance with the invention has greater utility since it may be implemented in other computing systems that are within the scope of the invention and it may be implemented in hardware (e.g., programmed into a programmable logic device) or a combination of software and hardware and the invention is not limited to any particular implementation of the system.

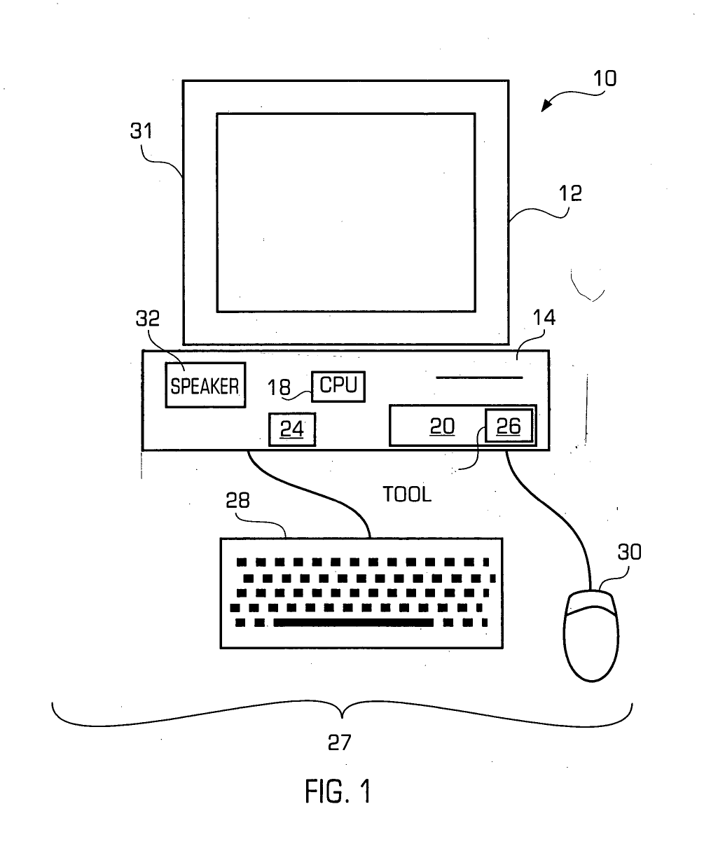

FIG. 1 is a diagram illustrating an example of a personal computer implementation of a design tool for over the phone voice enabled services. In particular, a personal computer 10 is shown that may execute a tool 26 that may be used to create designs for over the phone voice enabled services. The design tool may be preferably implemented in software comprising a plurality of lines of computer code that are executed by a processing unit 18 of the personal computer 10 to implements the functions of the design tool as described below in more detail. The design tool may also be implemented in hardware (programmed logic device) or in a combination of software and hardware and those alternatives are within the scope of the invention. In addition, the design tool 26 may be implemented on other computer architectures and systems, such as mainframe systems, client/server systems, peer-to-peer systems, mobile computing devices, PDAs or any computing device with sufficient processing power and memory (and connectivity if needed) to implement the design tool and these alternative implementations of the design tool system are within the scope of the invention.

For the personal computer implementation shown in FIG. 1, the computer 10 has a display device 12, such as a CRT or LCD device, and a chassis 14. The chassis 14 may include a processing unit 18, a memory 20, such as DRAM or SRAM or flash memory, and a persistent storage device 24. When the design tool functions are being executed by the personal computer, the tool 26 is loaded into the memory 20 and is executed by the processing unit 18. To permit the user to interact with the personal computer system (and the design tool 26), the computer 10 may have one or more input/output devices 27, such as a keyboard 28, a mouse 30 and a speaker 32. The computer 10 may have other input/output devices, such as a printer, an internet connection and the like as is well known.

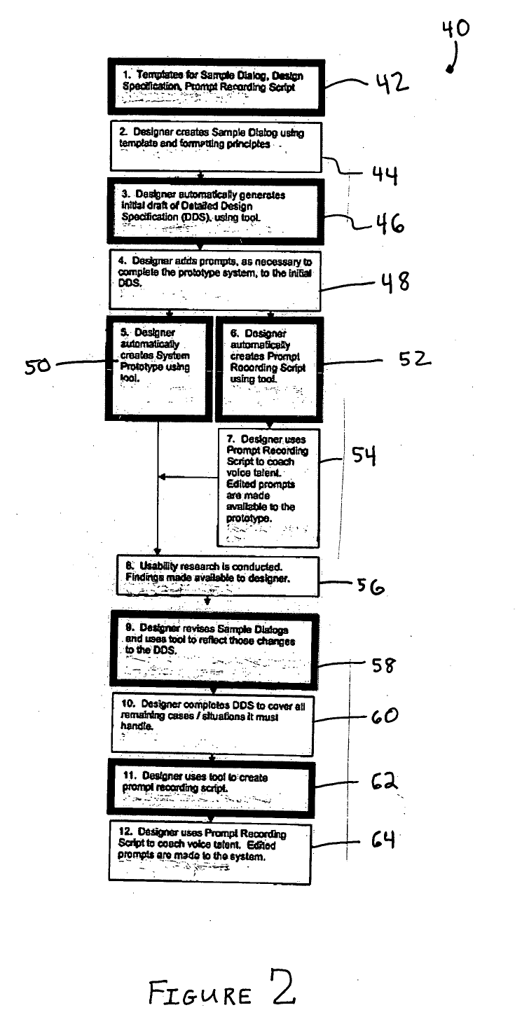

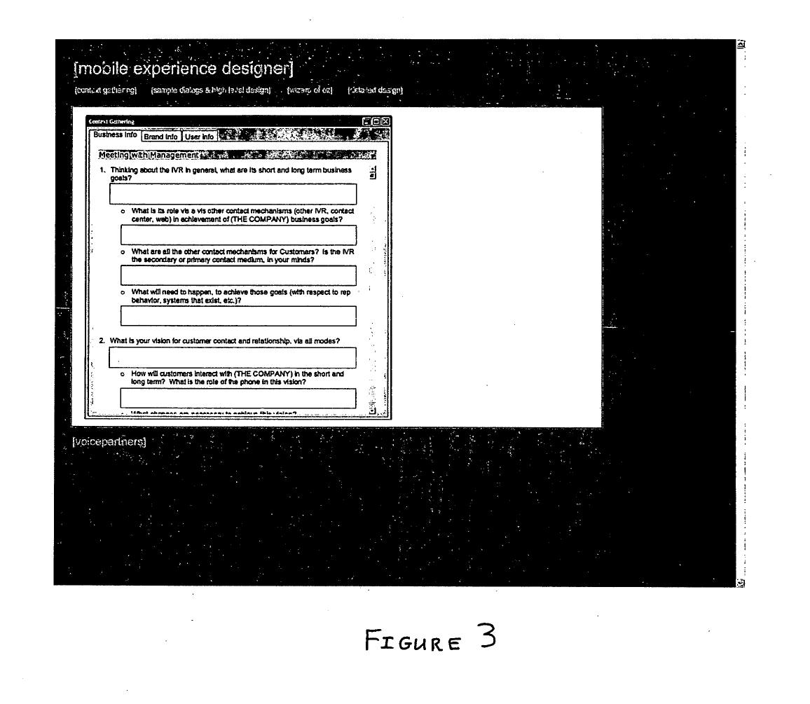

FIG. 2 is a flowchart illustrating a method 40 for over the phone voice enabled services design in accordance with the invention. This method may be implemented by the design tool 26 shown in FIG. 1. Examples of the user interface to implement some steps of the method 40 are shown in FIGS. 3-12. For example, FIG. 3 shows an example of a user interface that is used by the design tool to gather context for the design to be created including business information, brand information and user information.

Once the context information has been gathered (or the context information gathering step may be skipped), the design tool provides a format for sample dialogs, design specifications and/or prompt recording scripts described in step 42. The sample dialog format allows the designer to capture Sample Dialogs in such a way that the text form can be interpreted by the tool. In the preferred embodiment, the designer writes a sample interaction between the system and the caller, using specific format that will be interpreted by the tool wherein:
system and caller responses can be differentiated by specific formatting conventions provided by the tool; and
the above responses can be grouped together in distinct system states.

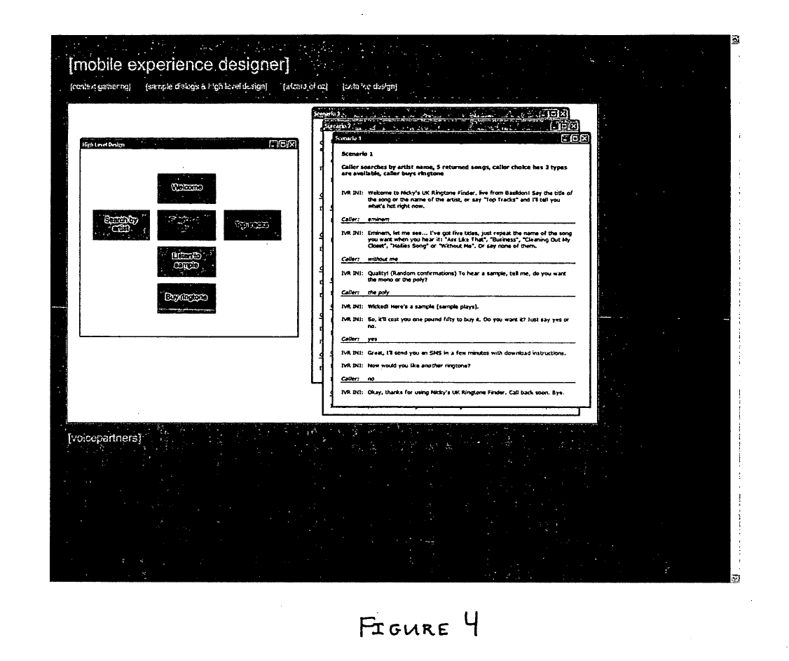

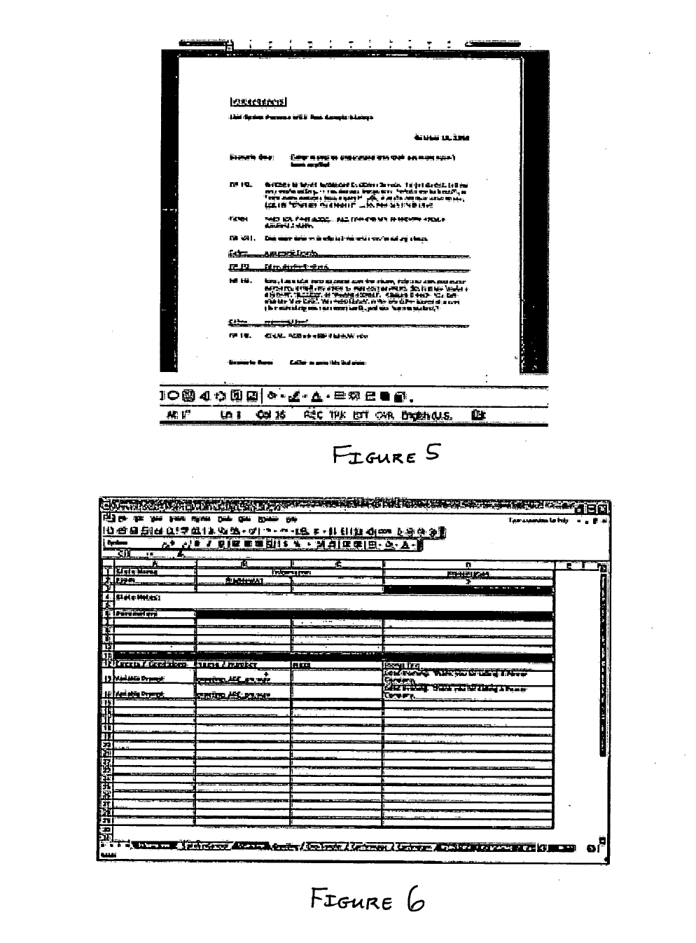

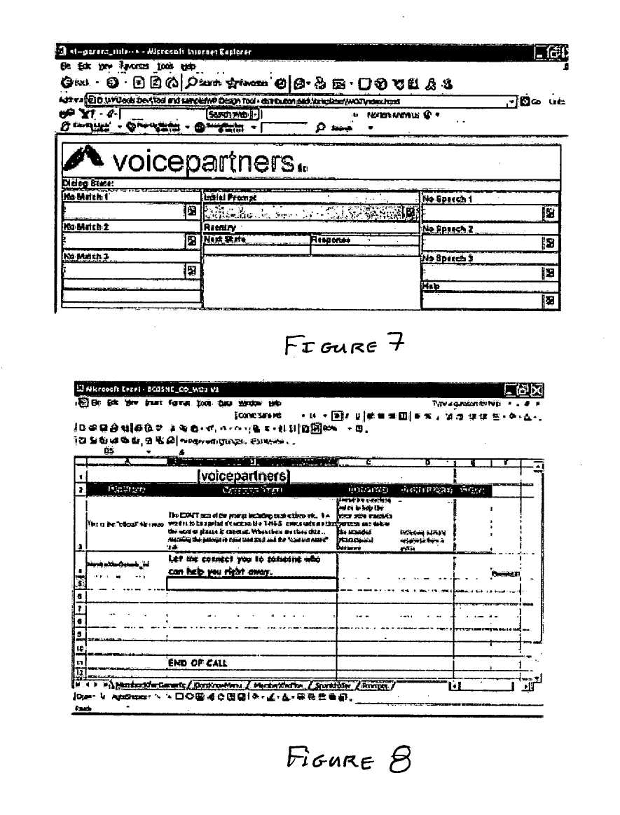

FIGS. 4 and 5 illustrate an example of a sample dialog that is used as a simple format that was created expressly for this purpose. FIG. 6 illustrates an example of a detailed design template that contains all the information that is ultimately necessary for coding the user interface of the over-the-phone voice recognition system. FIG. 7 illustrates an example of a prototype template (preferably implemented as an HTML document for portability) that provides a page format that will represent each “state” in the system flow. A prototype operator will click the appropriate link, given a particular response from the research respondent. That link will both play a recorded prompt (in the actual voice of the system) and move the prototype operator's screen to the next system “state”. Audio from the system is played into a phone, allowing a simulation of actual usage of the automated system over any telephone.

FIG. 8 illustrates an example of a prompt recording script template that provides a format that allows prompt recording “in context”. Because a conversation is context sensitive, it is crucial that a particular recorded phrase capture the prosody that is expected in the situation in which it will be heard. For example:

SYSTEM: “What's the account number?” (Normal query)

User: “um . . . 569 . . . 4 . . . I mean 64 . . . no, no . . .

SYSTEM: “What's the account number?” (Contrastive query: asked as a repeated F question might be asked)

This format is designed to make it as easy as possible to record and use prompts in context, via (1) naming conventions that note the prompts state and role in that state; (2) ordering prompts as the actual interaction will flow for the user (rather than in the order in which the DDS describes states for coding); and (3) space for coaching notes (which are added separately by the designer).

Returning to FIG. 2, in step 44, the designer using the design tool creates a sample dialog using the implicit formatting principles. Alternatively, the designer may use a design template, that embodies all of the detailed information necessary to create a voice-enabled service for a specific, common task. The design templates can be opened in the tool, and may be viewed and edited in any format: as sample dialogs, specifications, and/or prompt recording scripts. The design template may also be viewed as a research prototype.

FIG. 4 shows an exemplary user interface for sample dialogs and high level design for the design process. In a typical design process, this step may take about 3 days to complete. In particular, using the Sample Dialog format, the designer creates a sample dialog for each of the key tasks that callers will be completing in the system, noting what the system will say and expected caller responses for each exchange in the interaction. The sample dialog ensures that the system represents a useful conversation between the caller and the system, and requires the designer to understand key principles of conversational system design. At this time, the sample dialogs need only cover the tasks that potential callers will be completing in the usability research—which are generally the tasks that will be most frequently completed in the planned system. The use of appropriate formats will allow the sample dialog to be interpreted by the tool.

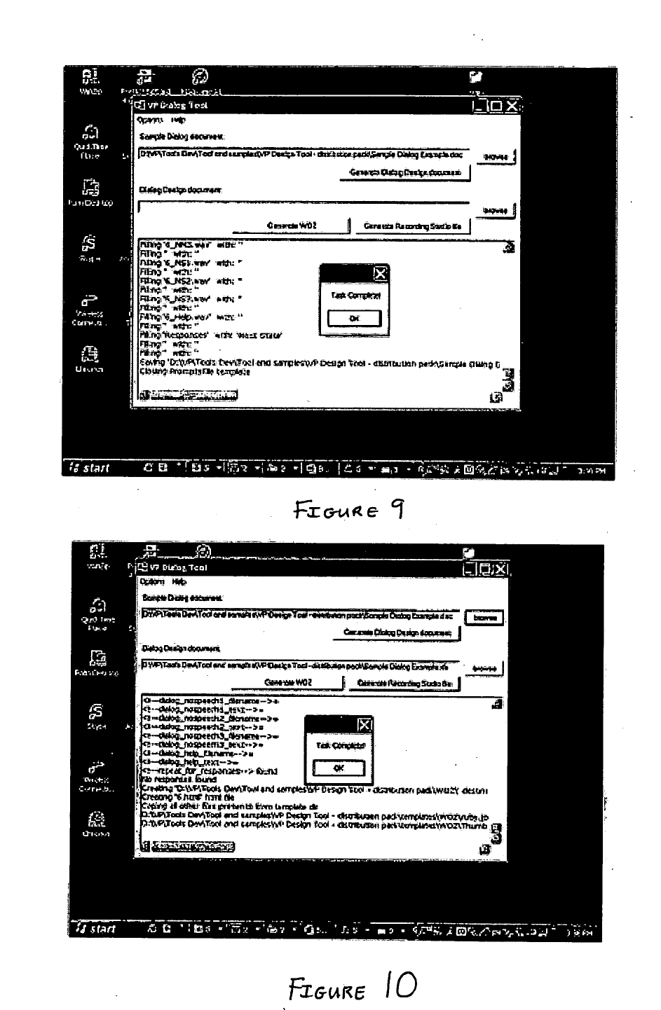

In step 46, the designer, using the design tool, switches view to look at the current design in the Detailed Design Specification (DDS) format. Using the design tool, this step can be preferably completed in far less than one minute. FIG. 9 illustrates an example of generating a detailed design specification during the design process. The designer can browse existing files to find the Sample Dialog that they would like to use as the basis for a particular specification or prototype. The draft DDS that the tool displays will include the initial prompt for each dialog state covered in the sample dialogs. The designer can easily add other supporting prompts (error recovery, system time outs used when the system does not hear any speech) in spaces provided and other notes necessary for coding in this format—see step 48 below. Note that creating the DDS from scratch (and without sample dialogs) can be very time consuming and error-prone, as it requires a state-by-state approach. In contrast, the sample dialog view of the design tool allow the designer to concentrate on the conversational nature of the interaction, and to identify the states they need to implement such design only later when fully satisfied by the conversation flow. This therefore reduces the re-work necessary to add states later in the process. The tool allows the framework of the DDS (the “main” system prompts) to be displayed by simply switching view from the sample dialog to the detailed design specs view, eliminating the effort of creating the spec by hand.

In step 48, the designer, using the design tool, adds prompts to the initial DDS, as necessary to complete the prototype system. This step may typically take less than 2 days to complete. Because Sample Dialogs do not include sub-routines dedicated to handling miscommunications between the system and the caller, additional prompts will need to be added to the specification by the designer.

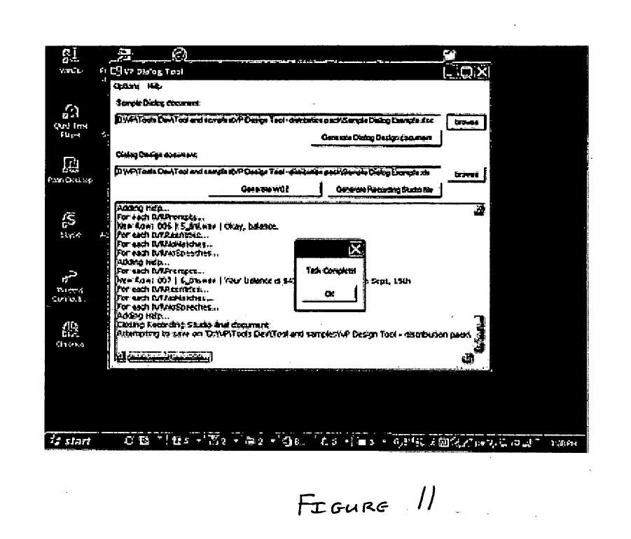

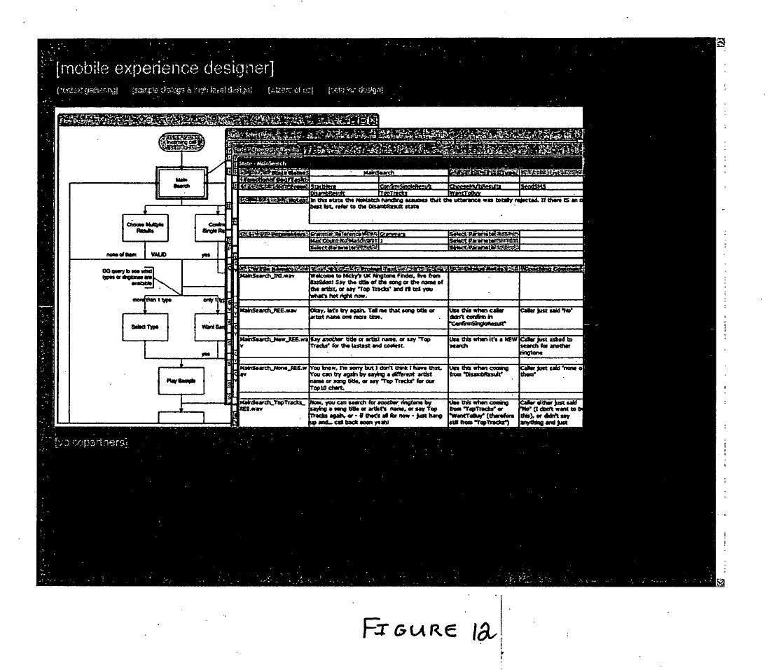

The steps 50 and 52 may be completed in parallel. FIG. 10 illustrates an example of generating a system prototype noted in step 50 of the design process, and FIG. 11 illustrates an example of generating a prompt recording script, as described in step 52 during the design process. In step 50, the designer, using the design tool, automatically generates the system prototype which typically takes less than a minute. In particular, once the designer is comfortable that the initial draft of the specification adequately represents the tasks that will be included in the research, the designer selects “Generate WOZ”, and the HTML prototype is created. Without this capability, a knowledgeable HTML developer must be involved, and the prototype must be hand-coded or created using an “off the shelf” HTML coding program like Dreamweaver. It can take as much as a week to code the prototype manually.

In step 52, the designer automatically creates the prompt recording script using the design tool wherein this step takes less than a minute. In particular, at the same time that the prototype is created, the designer clicks one additional button: “Generate Recording Studio File” so that a Prompt Recording Script will be automatically generated, enabling prompt recording in context. In a typical design process, the creation of the prompt recording script by hand copying the content from a DDS format into a document suitable for the recording studio and the voice talent can be tedious, and human errors are possible—in the accuracy of prompt names, mistakes in the content of the prompt itself, and/or missing other prompts entirely.

In step 54, the designer uses the prompt recording script to coach voice talent. This step may take about 1 day to complete, although time to record prompts varies with the complexity of the system. In particular, it is important that the prompts be recorded in the voice of artist that will be used for the actual system, and coached to ensure that the interaction reflects the linguistic principles that underlie the conversation. The design tool will double check the audio file names delivered from the studio against those expected, to make sure all the files are present, and correctly named. The edited prompts are then made available to the prototype.

In step 56, usability research is conducted with the findings made available to designer. This research step may take up to a week to complete. The prototype is used to play appropriate system audio into the telephone, simulating an over the phone interaction with a speech system for research respondents. After research has been completed, findings are communicated to the designer.

In step 58, the designer, using the design tool, revises the sample dialogs. This step generally takes one day or less. These changes will automatically be reflected in the DDS and other views. This approach ensures that the revisions solve problems in the conversation between caller and system, as intended. Translating revisions directly into the DDS may fix one known issue, but may undermine the overall conversation with the caller—as the end-to-end interaction can not be easily checked by reviewing a specification.

In step 60, the designer completes the DDS to cover all remaining cases/situations it must handle. This step may take from one to three weeks. In this step, the designer must move beyond the frequently completed tasks, and ensure that all use cases are handled by the system. The designer creates any remaining prompts in the specification. FIG. 12 illustrates an example of a user interface of the tool showing the detailed designs generated by the design process.

In step 62, the designer uses the design tool to create prompt recording script in less than one minute. Thus, once the DDS is complete, a push of a button will create the final recording script. In step 64, the designer uses the generated prompt recording script to coach voice talent and edited prompts are made for use in the system. The prompt recording script uses a particular file naming convention that denotes the role and placement of a particular prompt in the finished system. This naming convention has been proven to make it easier to implement and maintain the speech system. When the recorded audio files are returned from the studio, the software automatically double checks the names of finished files against what was expected from the recording studio, ensuring that prompt recording is as error free as possible. Manually, this step may take 2-5 days to complete.

The design process shown in FIG. 2 takes about 5 weeks to complete, with limited need for changes to the implemented system. This time period represents a roughly 30-50% reduction in time required to complete design specifications with typical processes.

### SUMMARY

The process facilitated by this tool is iterative, and focused on creating a more natural interaction that will generate higher customer satisfaction, be easier to use, encourage completion and, in fact, save time and money for the implementing company. The result of this automated system for the support of user-centered design is a higher quality, conversational interaction that can be created in far less time than creating and editing the various required documents by hand.

As noted above, companies currently design systems without reference to the user experience nor their ability to use the system—instead, they focus on efficiency of their internal systems. While many companies realize that (1) this is detrimental to the success of the ultimate system, and (2) it is not best practices for the design of conversational speech systems, they do not have the infrastructure necessary to implement this process now as each step currently occurs by hand, creating deliverables from “whole cloth”.

In accordance with the invention, the design tool may generate an eXtended markup language (XML) file that is output at the end of the design process. This XML file means that the output of the design tool may be more easily used to other software/tools to implement the over the phone voice enabled services.

The design tool (and the design process implemented using the design tool) provides various benefits over typical design processes that may include one or more of:
Automation and structural framework that will enable the implementing company to use a best practices process for user centered design of speech systems (starting with sample dialogs, testing an early prototype with users, and iterating the resulting design for better performance, PRIOR to finalizing the DDS)
Automation that will allow designers to re-use their sample dialogs to create a dialog specification. At present, any time invested in sample dialogs can not be applied towards any future deliverable—and this step is often skipped as a result.
Automation of prototype creation, eliminating build time for the prototype, and:
   allowing the designer to create their own prototypes (eliminating the need for the HTML programmer);
   Making it just as easy to usability test a prototype system as a finished system—eliminating the hurdle to the early design research that will save implementing companies time and money.
Automated creation of prompt recording scripts will ensure that prompt recording is as error free as possible.
Automated creation of a flowchart representing the design flow.
Ease of maintenance of the design when changes, improvements and new features must be added to a deployed system.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer implemented design tool for an over the phone voice enabled service, comprising:
a store that stores one or more design guides, the design guides further comprising a sample dialog format, a design specification format that is capable of storing details of the design for a particular over the phone voice enabled service and a prompt recording script format that is capable of directing the recording sessions for the particular over the phone voice enabled service;
a design tool that uses the sample dialog format, the design specification format and the prompt recording script format to generate a design for the particular over the phone voice enabled service; and
the design tool further comprising means for generating a sample dialog based on the sample dialog format, means for generating a draft detailed design specification based on the sample dialog, means for generating a flowchart based on the detailed design, means for generating a draft prompt recording script based on the prompt recording script format, means for generating a high fidelity prototype for early usability research and means for exporting a document that describes the completed design for the particular over the phone voice enabled service that is capable of being imported into any development environment.

2. The tool of claim 1, wherein the design tool further comprises a plurality of lines of computer code that are executed by a processing unit that is executing the design tool.

3. The tool of claim 2 further comprising a computing device having a processing unit wherein the computer code of the design tool is executed by the processing unit.

4. The tool of claim 3, wherein the exported document further comprises an XML document.

5. A method for designing an over the phone voice enabled service, the method comprising:
providing a sample dialog format, a design specification format that is capable of storing details of the design for a particular over the phone voice enabled service and a prompt recording script format that is capable of directing the recording sessions for the particular over the phone voice enabled service;
automatically generating a sample dialog based on the sample dialog format;
automatically generating a draft detailed design specification based on the sample dialog;
automatically generating a flowchart based on the design specification;
automatically generating a draft prompt recording script based on the prompt recording script format;
automatically generating a high fidelity prototype based on the draft detailed design; and
exporting a document that described the completed design for the particular over the phone voice enabled service that is capable of being imported into any development environment.

6. The method of claim 5, wherein the exported document further comprises an XML document.
